(19) United States
(12) Patent Application Publication
(10) Pub. No.: US 2018/0331531 A1
(43) Pub. Date: Nov. 15, 2018

(54) CIRCUIT BREAKER FOR A HIGH-VOLTAGE DC NETWORK, WITH FORCED OSCILLATION OF CURRENT

(71) Applicant: SUPERGRID INSTITUTE, VILLEURBANNE (FR)

(72) Inventors: Christophe CREUSOT, PIZAY (FR); Alain GIRODET, CHASSIEU (FR); Michel MERMET GUYENNET, BELLEYDOUX (FR); Alberto BERTINATO, LYON (FR)

(21) Appl. No.: 15/776,118

(22) PCT Filed: Nov. 16, 2016
(86) PCT No.: PCT/FR2016/052971

§ 371 Date: May 15, 2018

(30) Foreign Application Priority Data
Nov. 17, 2015 (FR) 15 61022

(51) Int. Cl. H02H 3/05; H02H 3/02; H02H 3/087

(52) U.S. Cl. CPC H02H 3/05; H02H 3/087; H02H 3/021

(57) ABSTRACT

The invention relates to circuit breaker apparatus for a high- or medium-voltage direct current network, the circuit breaker apparatus comprising a branch (A-A′) with a mechanical circuit breaker (S1) inserted in the network line, and, connected in parallel therewith, firstly a lightning arrestor (5) branch, and secondly a series connection of a first capacitor bank (C), a make switch (S2), and an inductor.

According to the invention, the circuit breaker apparatus includes at least one resistive voltage divider (Rs) connected to the network voltage and presenting a low voltage stage (R1s) connected in parallel with the capacitor bank (C) in order to charge the capacitor bank.

### FIELD

The present disclosure relates to the general technical field of circuit breaker apparatus designed in particular to open on load the electrical circuit in which it is interposed, and more precisely the disclosure relates to circuit breaker apparatus for a high- or medium-voltage direct current network with forced injection of an oscillating current.

The disclosure finds particularly advantageous applications in the technical field of protecting multipoint high voltage direct current (HVDC) networks or multipoint medium voltage direct current (MVDC) networks. The circuit breaker apparatus of the disclosure makes it possible to protect such a network together with the associated alternating current/direct current (AC/DC) converters in the event of a fault appearing in such a network.

### BACKGROUND

With the development of DC networks and of multipoint DC networks based on DC converters, DC circuit breaker apparatus has become a key element enabling stable, safe, and reliable operation to be guaranteed.

In AC networks, the current crosses zero twice in each cycle, such that an AC circuit breaker makes use of the natural current zero crossing in order to interrupt it. In a DC network, there is no natural zero crossing for the direct current, such that interrupting the current is more complex.

In the state of the art of DC networks, it is known to make use of a power electronic system based on insulated gate bipolar transistors (IGBTs) in order to interrupt a fault DC current directly. Although such systems enable the current to be interrupted quickly, that solution is prohibitively expensive, and in normal operation leads to large conduction losses.

Another known solution is said to be “hybrid” or “mechatronic”, and it comprises firstly a primary branch with an electronic power device connected in series with an ultrafast mechanical disconnector, and secondly, in parallel, an electronic power device. On the appearance of a fault, the electronic power device in the primary branch, interrupts the current and the mechanical disconnector opens. The current is switched into the parallel branch, which eliminates the fault. That solution presents the advantage of reducing conduction losses and of breaking at very high speed. However that solution requires a plurality of devices to be connected both in series and in parallel, thus needing control that is complicated.

Also known from patent application WO 2012/100831 is circuit breaker apparatus for an HVDC network that comprises one branch with a mechanical circuit breaker inserted in the network line, and, connected in parallel therewith, both a lightning arrestor and a series connection of a make switch, an inductor, and a capacitor precharged with a negative voltage. On the appearance of a fault current, the make switch serves to transfer the current into the capacitor branch in order to reduce and stop the flow of current in the mechanical circuit breaker branch.

Another solution is also known that uses a mechanical circuit breaker capable of eliminating a fault current providing it presents zero crossings. However, in a DC network, since the fault current does not present zero crossings, such a mechanical circuit breaker is associated with a circuit for injecting an oscillating current so that the fault current can be caused artificially to present a zero crossing. Typically, the mechanical circuit breaker has connected in parallel therewith a series connection comprising a first capacitor bank, a make switch, and an inductor. On the appearance of a fault current, the make switch then causes the capacitor bank to discharge through the inductor so as to produce a zero crossing in the current flowing through the branch with the mechanical circuit breaker.

In the variant embodiment described in the publication AORC Technical Meeting 2014, B4-1120, Mitsubishi, “HVDC breakers for HVDC grid applications”, an AC source is used for charging the capacitor bank. Thus, that solution is expensive since it requires the use of an auxiliary source and a make switch (stacks of thyristors or insulated grid bipolar transistors, or a plasma-controlled spark gap) operating at the network voltage.

Likewise, the publication IEEE Transactions on Power Apparatus Systems, Hitachi, 1985 “Development and interrupting tests on 250 kV 8 kA HVDC circuit breaker” proposes that the capacitor bank should be charged by the network to the network voltage so that the make switch also operates at the network voltage.

Patent application CN 10333785 does not describe the circuit for charging the capacitor bank, and provides for using a plurality of electronic power devices with control monitoring, which devices are also used for working at the network voltage.

### SUMMARY

The present disclosure seeks to remedy the above-mentioned drawbacks by proposing circuit breaker apparatus for a high- or medium-voltage direct current network, which apparatus that uses a mechanical circuit breaker associated with a circuit for injecting an oscillating current, such circuit breaker apparatus being designed to avoid needing the use of an auxiliary voltage source, while not requiring the various electronic components to work at the network voltage.

In order to achieve such an object, the circuit breaker apparatus for a high- or medium-voltage direct current network comprises a branch with a mechanical circuit breaker inserted in the network line, and, connected in parallel therewith, firstly a lightning arrestor branch, and secondly a series connection of a first capacitor bank, a make switch, and an inductor, the make switch acting on the appearance of a fault current to discharge the capacitor bank through the inductor so as to produce a zero crossing in the current flowing in the mechanical circuit breaker branch.

According to the disclosure, the circuit breaker apparatus includes at least one resistive voltage divider connected to the network voltage and presenting a low voltage stage connected in parallel with the capacitor bank in order to charge the capacitor bank.

The circuit breaker apparatus of the disclosure further comprises in combination one and/or more of the following characteristics:
the first resistive voltage divider together with the capacitor bank presents a charging time constant shorter than 100 milliseconds (ms);
the first resistive voltage divider presents a ratio between the high voltage stage and the low-voltage stage lying in the range 0.05 to 0.25;

a second resistive voltage divider connected to the network voltage and presenting a low voltage stage connected in parallel with the capacitor bank, the resistance of the low-voltage stage of the first divider being less than the resistance of the low-voltage stage of the second divider, with the division ratio of the first resistive voltage divider being equal to the ratio of the second resistive voltage divider, the stages of the first divider including controlled switches that are caused firstly to close in order to charge the capacitor bank quickly, and secondly to open after charging in order to enable the second divider to maintain the charge of the capacitor bank;
a branch with a second capacitor bank connected in parallel with the low-voltage stage of the first resistive voltage divider and presenting capacitance identical to the capacitance of the first capacitor bank, the first and second capacitor banks each being connected in series with a respective controlled switch, one of which is caused to close on the appearance of a fault current in order to discharge the associated capacitor bank so as to produce a zero crossing in the current flowing through the mechanical circuit breaker branch, and the other of which is caused to close in the event of re-closing on a fault in order to discharge the associated capacitor bank so as to produce a zero crossing in the current flowing in the mechanical circuit breaker branch;
a system for discharging the capacitor bank, after eliminating the fault current;
as a system for discharging the capacitor bank, the controlled switches of the first resistive divider and the high voltage stage of that first divider, the controlled switches being caused to close in order to discharge the capacitor bank; and
a control circuit for the make switch and for the isolating switch serving firstly, after opening of the mechanical circuit breaker, to close the make switch quickly in order to produce the alternating current, and secondly to open the isolating switch in order to reinitialize charging of the capacitor bank so as to be ready for a subsequent circuit breaking operation.

Various other characteristics appear from the following description made with reference to the accompanying drawings which show embodiments of the disclosure as non-limiting examples.

### BRIEF DESCRIPTION OF THE DRAWINGS

FIG. 1 is a circuit diagram of circuit breaker apparatus in accordance with the disclosure.

FIG. 2 is a diagram of a first variant embodiment of the circuit breaker apparatus of the disclosure, including two resistive voltage dividers.

FIG. 3A is a diagram showing the step of charging the capacitor bank of the circuit breaker apparatus shown in FIG. 2.

FIG. 3B shows the waveform of the voltage charging the capacitor bank of the circuit breaker apparatus in the step of FIG. 3A, and shows the waveform of the currents flowing in the network line.

FIG. 4A is a diagram of the circuit breaker apparatus showing the step of maintaining the charge of the capacitor bank.

FIG. 4B shows the waveform of the voltage for charging the capacitor bank of the circuit breaker apparatus in the step of FIG. 4A.

FIG. 5A is a diagram showing the circuit breaker apparatus on the appearance of a fault current.

FIG. 5B shows the waveform of the network current on the appearance of a fault current and the waveform of the voltage for charging the capacitor bank.

FIG. 6A is a diagram of the circuit breaker apparatus showing the step of opening the mechanical circuit breaker of the circuit breaker apparatus.

FIG. 6B shows the waveform of the network current on the appearance of a fault current and the waveform of the voltage for charging the capacitor bank.

FIG. 7A is a diagram of the circuit breaker apparatus showing the step of discharging the capacitor bank in order to create an oscillating current.

FIG. 7B corresponds to the discharge step shown in FIG. 7A and shows the waveform of the network current and the waveform of the voltage for charging the capacitor bank.

FIG. 8A is a diagram of the circuit breaker apparatus showing the first stage of discharging the capacitor bank in order to enable it to be reinitialized.

FIG. 8B, corresponding to the discharge step shown in FIG. 8A, shows the waveform of the voltage of the capacitor bank.

FIG. 9A is a diagram of the circuit breaker apparatus showing the second stage of discharging the capacitor bank in order to enable it to be reinitialized.

FIG. 9B corresponds to the discharge step shown in FIG. 9A and shows the waveform of the voltage of the capacitor bank.

FIG. 10 is a diagram of a second variant embodiment of the circuit breaker apparatus of the disclosure, having two banks of capacitors.

### DESCRIPTION

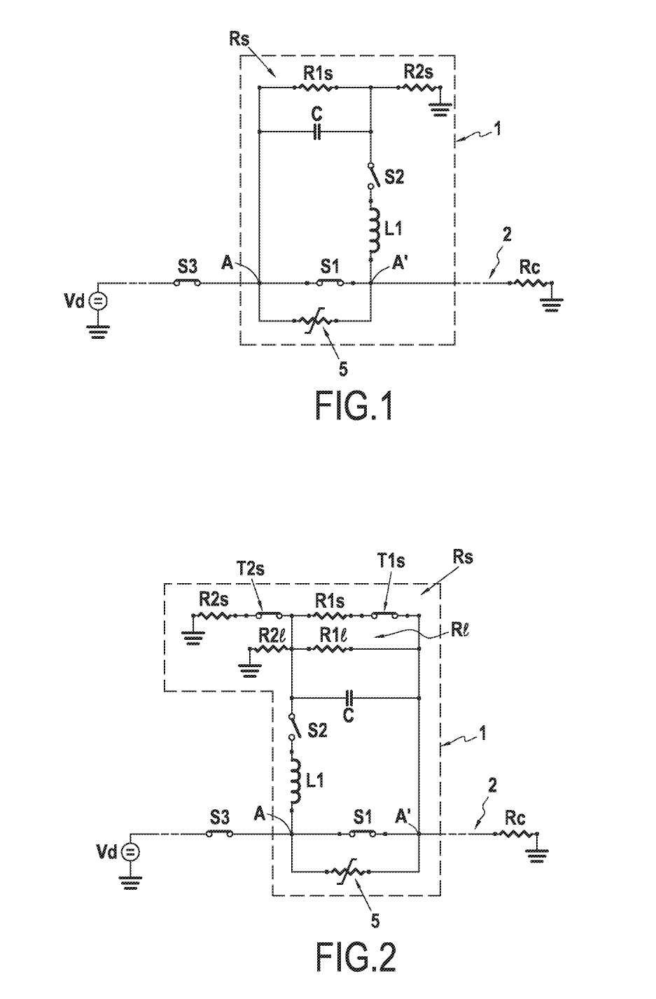

As can be seen from the drawings, and in particular from FIG. 1, the subject matter of the disclosure relates to circuit breaker apparatus 1 for a high- or medium-voltage DC network 2 with forced injection of an oscillating current. The circuit breaker apparatus 1 of the disclosure makes it possible to protect such a network and its associated AC/DC converters on the appearance of a fault in such a network. Typically, such circuit breaker apparatus 1 is placed between the DC outlet of such a converter and the DC network. In the drawings, the DC network 2 is represented by a line having inserted therein, between points A and A′, the circuit breaker apparatus 1, and it comprises on one side a load resistance Rc and on the other side a DC source Vd.

The circuit breaker apparatus 1 in accordance with the disclosure comprises a branch A-A′ with a mechanical circuit breaker S1 inserted in the DC network line 2. The term “mechanical circuit breaker” S1 is used to designate an apparatus in which the active circuit breaking members are enclosed in a sealed enclosure filled with an insulating fluid or else with a high vacuum of less than 10⁻⁵ millibars (mbar). Such a fluid may be a gas, commonly but not exclusively sulfur hexafluoride (SF₆), however liquids or oils are also used. This insulating and current-interrupting medium is selected for its insulating nature, in particular so as to present dielectric strength greater than that of dry air at equivalent pressure, and also for its capacity to interrupt current.

In parallel with the branch A-A′, there is a series connection of a first capacitor bank C, a make switch S2, and an inductor L1. The make switch S2 is opened and closed under the control of a control circuit (not shown) so that, on the appearance of a fault current, it discharges the capacitor bank C through the inductor so as to produce a zero crossing in the current flowing in the branch containing the mechanical circuit breaker S1.

The circuit breaker apparatus 1 in accordance with the disclosure is designed to enable the capacitor bank C to be charged by the AC/DC converter, or as shown in the example of FIG. 1, by the high voltage line, via at least a first resistive voltage divider Rs. The divider has a low voltage stage R1s connected in parallel with the capacitor bank C and a high voltage stage R2s. By appropriately selecting the division ratio of this resistive voltage divider, it is possible to work with a bank-charging voltage of a few tens of kilovolts (kV), thereby increasing its lifetime (instead of working continuously at the network voltage, i.e. 320 kVdc). In this circuit, the make switch S2 operates at a low voltage, namely the charging voltage of the capacitor bank, thereby making it accessible at low cost for a controlled spark gap or for a stack of thyristors or of insulated gate bipolar transistors (IGBTs).

Upstream from the circuit breaker apparatus 1, between the DC source and the point A, an isolating switch S3 is connected in series therewith, which isolating switch is suitable for discharging the capacitor bank C, as explained in the description below.

According to some embodiments characteristic, the first resistive voltage divider Rs presents a division ratio between the high voltage stage R2s and the low voltage stage R1s lying in the range 0.05 to 0.25. Typically, the resistance of the high voltage stage R2s lies in the range 1.5 megohms (MΩ) to 10 MΩ, and the resistance of the low voltage stage R1s lies in the range 0.1 MΩ to 2.5 MΩ.

Finally, still in parallel with the branch A-A′, there is a lightning arrestor branch 5. This branch comprises a lightning arrestor 5, i.e. a device for providing protection against any known type of surge voltage. The lightning arrestor 5 is provided to set the maximum surge voltage across the terminals of the capacitor bank C and the mechanical circuit breaker S1 and to absorb energy from the network after circuit-breaking by the mechanical circuit breaker S1.

FIG. 2 shows a first variant embodiment of circuit breaker apparatus 1 in accordance with the disclosure having a first resistive voltage divider Rs connected to the network voltage and a second resistor voltage divider Rl also connected to the network voltage. The first resistive voltage divider Rs is used to charge the capacitor bank C rapidly while presenting high losses over a very short duration. The second resistive voltage divider Rl is used for taking over from the first resistive voltage divider so as to continuously maintain the charge of the capacitor bank C, while presenting continuous losses that are low.

Together, the first resistive voltage divider Rs and the capacitor bank C present a charging time constant of less than 100 milliseconds (ms).

The first resistive voltage divider Rs has a low voltage stage R1s and a high voltage stage R2s. The low voltage stage R1s is connected in parallel with the capacitor bank C in order to charge the capacitor bank. This low voltage stage R1s includes in series a controlled switch T1s that performs a function that is described in detail in the description below. The high voltage stage R2s is connected to electrical ground and includes in series a controlled switch T2s that performs a function that is described in detail below. The controlled switches T1s and T2s are opened and closed under the control of the control circuit associated with the circuit breaker apparatus 1.

The second resistive voltage divider Rl has a low voltage stage R1l and a high voltage stage R2l. The low voltage stage R1l is connected in parallel with the capacitor bank C in order to charge the capacitor bank. The high voltage stage R2l is connected to electrical ground.

According to some embodiments characteristic, the resistance of the low resistance stage R1s of the first resistive voltage divider Rs is less than the resistance of the low voltage stage R1l of the second resistive voltage divider Rl. According to another embodiment characteristic, the division ratio of the first resistive voltage divider Rs is equal to the ratio of the second resistive voltage divider Rl. As mentioned above, the division ratio of each resistive voltage divider Rs and R l lies in the range 0.05 to 0.25. Typically, for the first resistive voltage divider Rs, the electrical resistance of the low voltage state R1s lies in the range 1 kilohms (kΩ) to 100 kΩ, and the electrical resistance of the high voltage stage R2s lies in the range 20 kΩ to 400 kΩ.

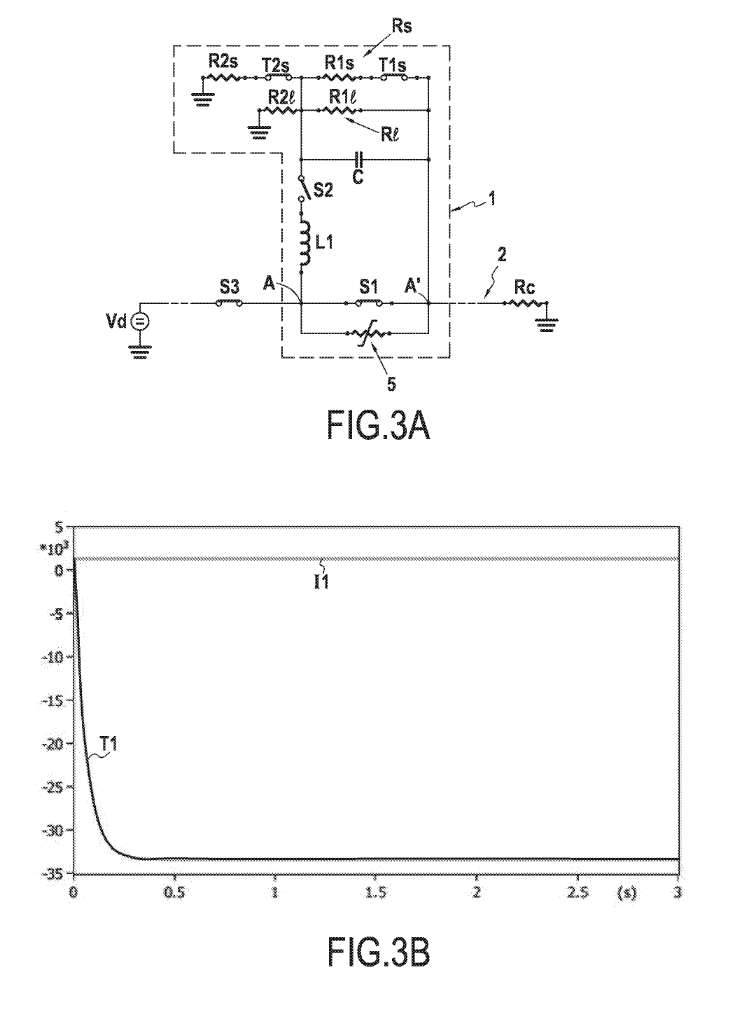

FIGS. 3A-3B to 9A-9B show the principal steps in the operation of the circuit breaker apparatus 1 shown in FIG. 2.

The first step shown in FIGS. 3A-3B concerns rapid charging of the capacitor bank C. For this purpose, the mechanical circuit breaker S1 is closed and the make switch S2 is open. It should be observed that the isolating switch S3 connected in series with the circuit breaker apparatus 1 is closed. The controlled switches T1s and T2s of the first resistive voltage divider Rs are closed so as to provide rapid charging of the capacitor bank C via the first resistive voltage divider Rs. The waveform of the charging voltage for the capacitor bank C is shown by curve T1 in FIG. 3B, which also shows the waveform of the current flowing in the network line, i.e. through the mechanical circuit breaker S1 (curve I1).

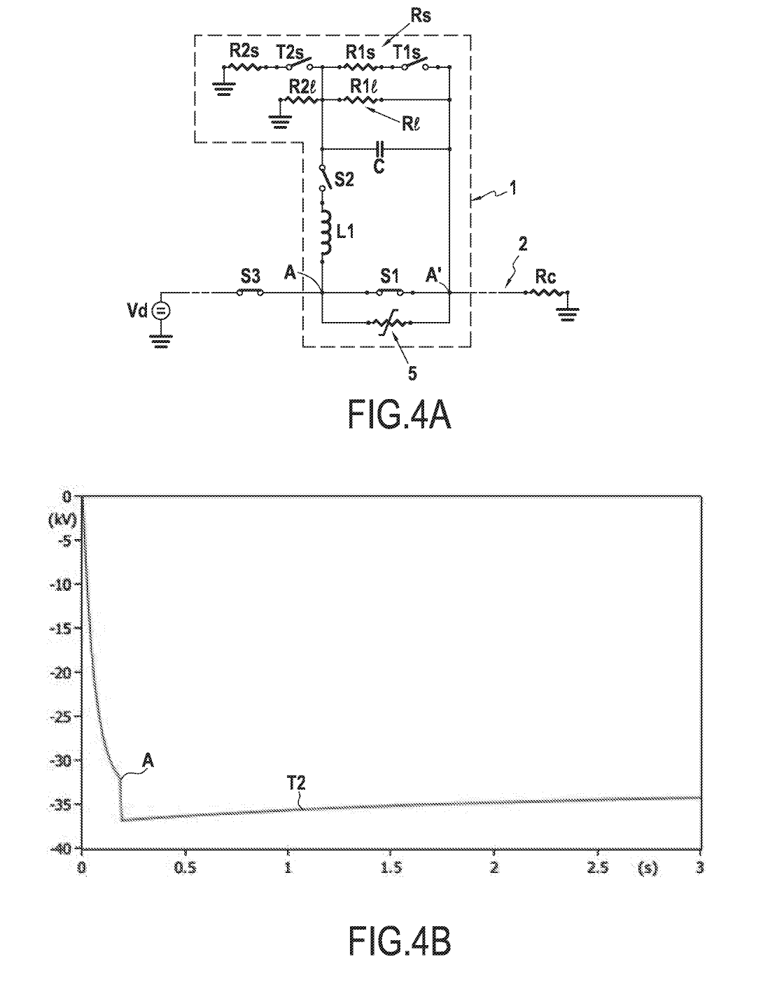

The second step shown in FIGS. 4A-4B relates to maintaining the charge of the capacitor bank C at a permanent value while presenting low losses. For this purpose, the controlled switches T1s and T2s of the first resistive voltage divider Rs are open, while the mechanical circuit breaker S1 remains closed and the make switch S2 remains open. It should be observed that the isolating switch S3 connected in series with the circuit breaker apparatus 1 is closed.

The controlled switches T1s and T2s are opened in order to enable the first resistive voltage divider Rs to be disconnected and the second resistive voltage divider Rl to be connected to the terminals of the capacitor bank C. The controlled switches T1s and T2s are controlled to occupy the open position before the capacitor bank reaches full charge so that charging the capacitor bank C is terminated by using the second resistive voltage divider Rl. The waveform of the voltage charging the capacitor bank C is shown by curve T2 in FIG. 4B, which shows a charging transition at a point A between the first resistive voltage divider Rs and the second resistive voltage divider Rl. The second resistive voltage divider Rl thus acts continuously to maintain the charge of the capacitor bank C, while presenting continuous losses that are low.

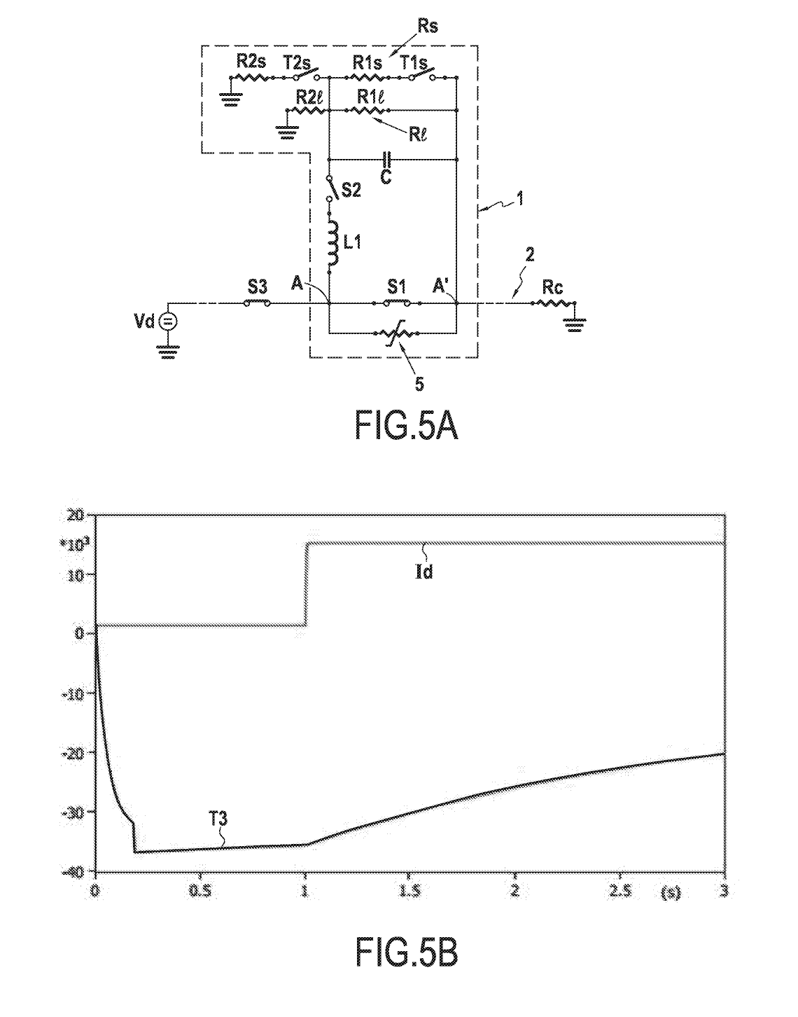

The following step shown in FIGS. 5A-5B shows the appearance of a fault current Id on the network line. The appearance of this fault current leads to a reduction in the capacitance of the capacitor bank, as can be seen from curve T3 in FIG. 5B showing the charge curve of the capacitor bank. It should be observed that the high voltage stage R2l that presents large resistance is adapted to limit the discharging of the capacitor bank during the appearance of this fault current.

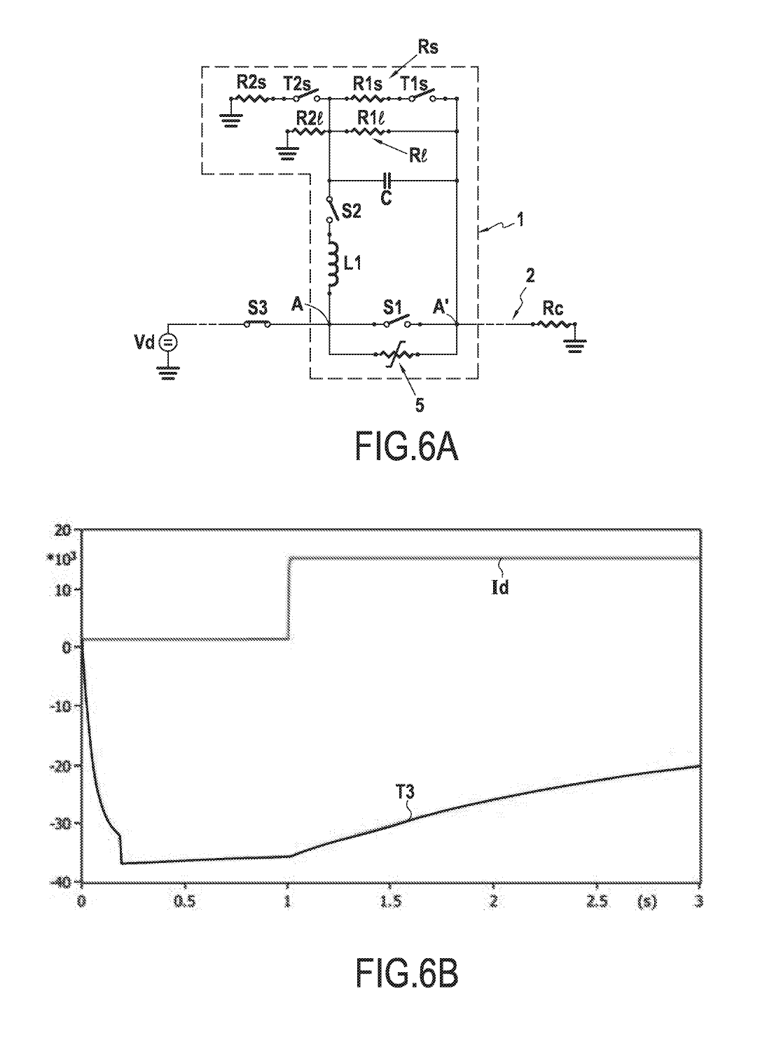

After the appearance of the fault current, the mechanical circuit breaker S1 is controlled to open, as shown in FIGS. 6A-6B, by a control order coming from a protection circuit. Conventionally, an electric arc appears within the mechanical circuit breaker S1. As explained below, the capacitor bank does not discharge its charge instantaneously on the appearance of the fault current, because of the large resistance of the high voltage stage R2l.

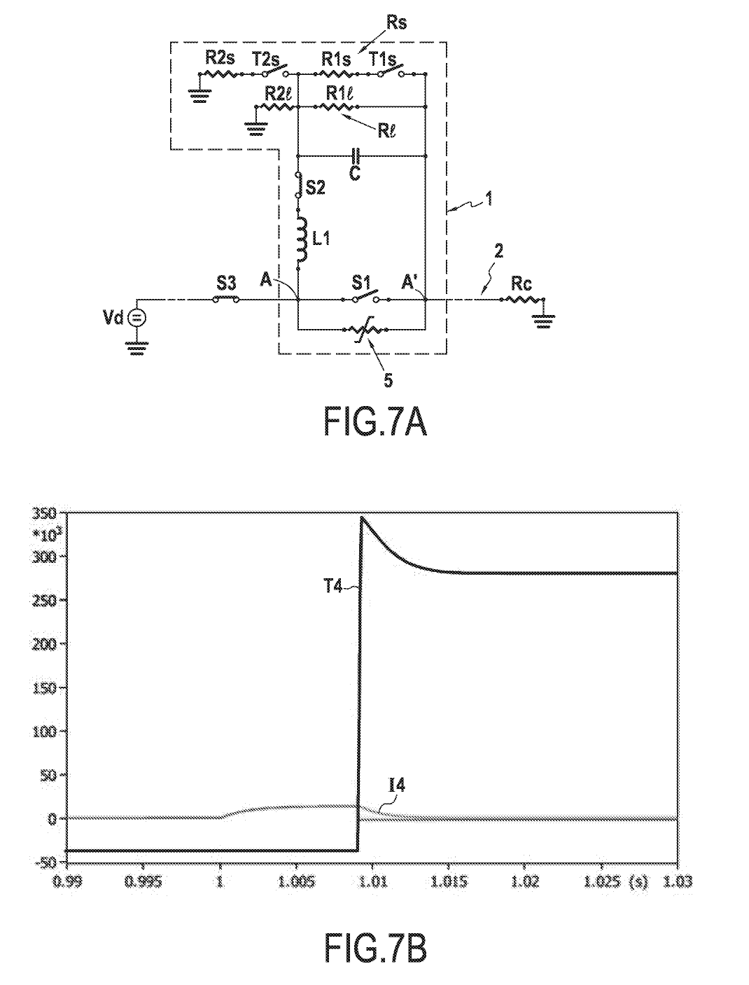

The following step is shown in FIGS. 7A-7B, which show the capacitor bank C discharging into the mechanical circuit breaker S1. For this purpose, the make switch S2 is closed so as to allow the capacitor bank to discharge into the circuit formed by the inductor L1 and the mechanical circuit breaker S1 so as to create a high frequency oscillating current that is superposed on the fault current passing through the mechanical circuit breaker S1. Naturally, the oscillating current as created in this way must present a first peak value that is greater than the fault current that is to be eliminated.

The amplitude of the oscillating current Ip is such that:

$${I}_{p} = Uch \cdot \sqrt{\frac{C}{L}}$$

The frequency of the oscillating current is such that:

$$f = \frac{1}{2 π \sqrt{L \cdot C}}$$

The power dissipated by a divider is such that:

$$P = \frac{{U}^{2}}{R 1 + R 2}$$

The current per divider is such that:

$$I = \frac{U}{R 1 + R 2}$$

The voltage across the terminals of the capacitor bank is such that:

$$Uch = U \cdot \frac{R 1}{R 1 + R 2}$$

The charging time constant is such that:

$$Tau = \frac{R 1 \cdot R 2}{R 1 + R 2} \cdot C$$

Thus, by setting the oscillating voltage and current magnitudes, it is possible to determine the values for the resistances of the resistive voltage dividers Rs, Rl, for the inductance L1, and for the capacitance of the capacitor bank.

For example, if the value of the fault current is equal to 16 kiloamps (kA), then the components of the circuit breaker apparatus are selected so that the peak value of the oscillating current reaches 20 kA.

It should thus be understood that the current passing through the mechanical circuit breaker S1 presents a zero crossing such that the mechanical circuit breaker S1 is capable of eliminating such a fault current. The mechanical circuit breaker S1 then opens the branch A-A′ of the network.

Given this opening of the branch containing the mechanical circuit breaker S1, the current flows around that branch and can pass through the circuit formed by the inductor L1 and the capacitor bank C. The capacitor bank is thus charged by the network so that its voltage increases, as shown by curve T4 in FIG. 7B.

Nevertheless, it should be observed that the lightening arrestor 5 is connected to the terminals of the capacitor bank C. The lightning arrestor 5 thus peak-limits the voltage of the capacitor bank to a given value such that current no longer flows through the capacitor bank C but instead through the branch containing the lightning arrestor 5. The voltage of the capacitor bank thus stabilizes at substantially the network voltage. The lightning arrestor 5 then passes current and absorbs energy such that the current in the line becomes zero (current curve 14 in FIG. 7B). The circuit breaker apparatus 1 in accordance with the disclosure has performed a break operation that eliminates the fault current.

The following operation consists in discharging the capacitor bank C in which the voltage has reached the voltage value of the network so that the capacitor bank can be reinitialized, i.e. recharged with its value for producing the desired oscillating discharge current.

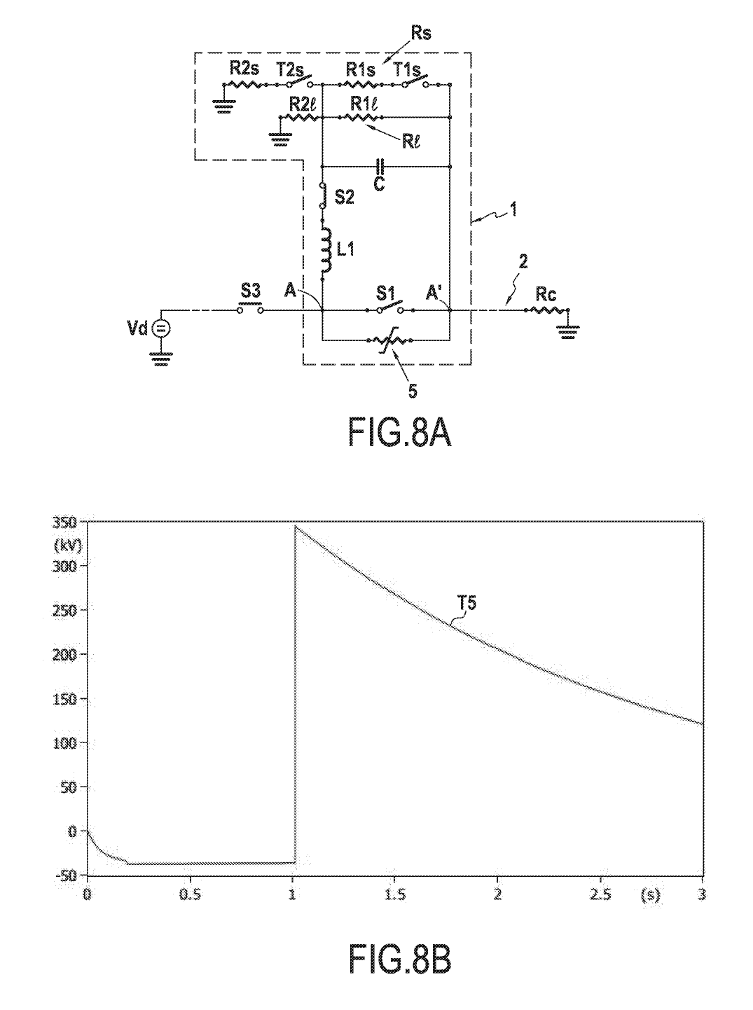

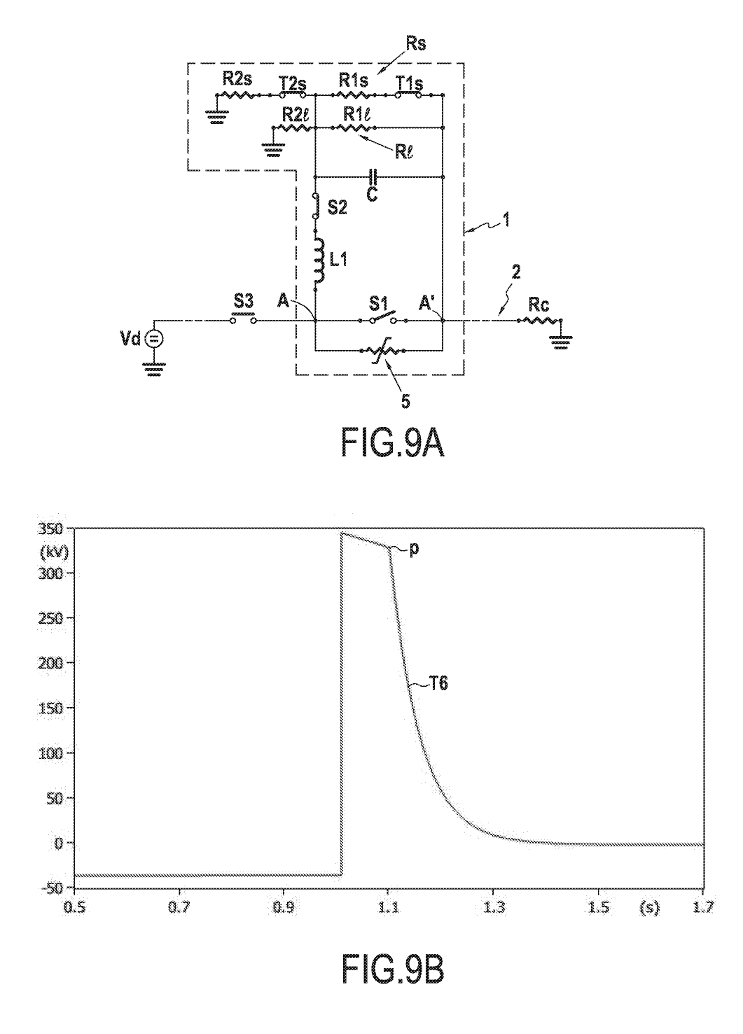

FIGS. 8A-8B and 9A-9B show this operation of discharging the capacitor bank C, which is performed in two stages. Firstly, the isolating switch S3 is caused to open so that the capacitor bank C is discharged with the time constant of the second resistive voltage divider Rl (FIG. 8A). It should be recalled that the time constant of the second resistive voltage divider Rl is relatively long, such that the speed of discharge is relatively slow, as can be seen from curve T5 in FIG. 8B which plots the voltage of the capacitor bank.

Thereafter, as shown in FIG. 9A, the controlled switches T1s and T2s are caused to close so as to connect the first resistive voltage divider Rs to the terminals of the capacitor bank C. Thus, the capacitor bank C discharges with the time constant of the first resistive voltage divider Rs. It should be recalled that the time constant of the first resistive voltage divider Rs is relatively short, such that the speed of discharge is relatively fast, as can be seen from curve T6 in FIG. 9B which plots the voltage of the capacitor bank. The point P in curve T6 corresponds to the changeover from discharging via the second resistive voltage divider Rl and discharging via the first resistive voltage divider Rs.

Once the fault current has been eliminated and the capacitor bank C has been discharged or is discharging, the make switch S2 is opened prior to closing the mechanical circuit breaker S1 and the isolating switch S3 that is connected in series with said mechanical circuit breaker S1. As explained with reference to FIGS. 3A and 3B, the capacitor bank C charges quickly and opening the controlled switches T1s and T2s makes it possible to maintain the charge of the capacitor bank C (FIGS. 4A-4B).

After charging the capacitor bank, the circuit breaker apparatus 1 of the disclosure is once more ready to perform another circuit breaking operation as soon as a fault current appears. The various steps described above are repeated.

It can be seen from the above description that the circuit breaker apparatus 1 of the disclosure does not need an auxiliary voltage source, thereby increasing its reliability and decreasing its cost. Furthermore, the charge voltage of the capacitor bank reaches a value of several tens of kV, which is very far from the permanent value of the network, thereby improving the aging of the capacitor bank. Likewise, the make switch S2 also operates at a voltage of a few tens of kV, and not at the network voltage, even during a circuit breaking stage. The make switch S2 can therefore be of low cost, e.g. being formed by a “fast triggered” or “controlled” spark gap, a stack of thyristors, or a stack of insulated gate bipolar transistors (IGBTs).

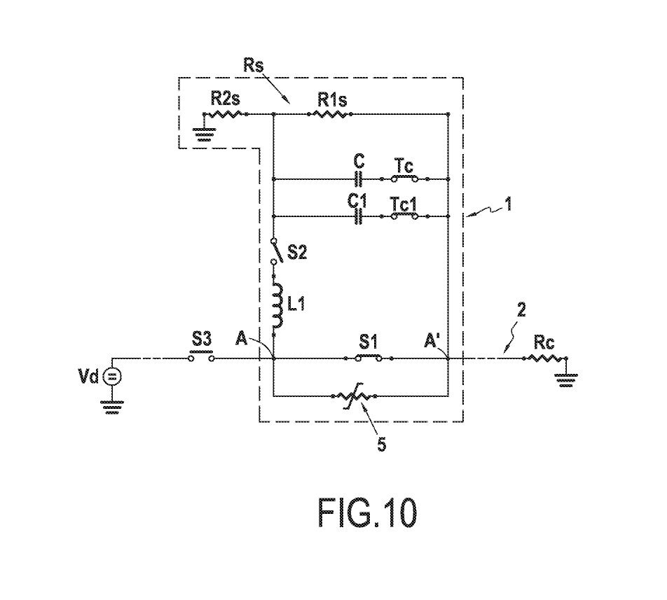

FIG. 10 shows a second variant embodiment of the circuit breaker apparatus 1 in accordance with the disclosure enabling two successive circuit breaking operations to be performed in a very short time interval, typically shorter than 100 ms. In the variant embodiment shown in the drawings, the circuit breaker apparatus 1 has only one resistive voltage divider Rs as in the example shown in FIG. 1, but it has a second capacitor bank C1 arranged in parallel with the first capacitor bank C. The second capacitor bank C1 is thus connected in parallel with the low voltage stage R1s of the resistive voltage divider Rs and presents capacitance identical to that of the first capacitor bank C. Each of the first and second capacitor banks is connected in series with a respective controlled switch Tc, Tc1.

The operation of this second variant embodiment is identical in principle to the operation of the first variant described in detail with reference to FIGS. 3A to 9A. A difference relates to charging the two capacitor banks, which charging is performed simultaneously through a single resistive voltage divider Rs or through two parallel resistive voltage dividers Rs and Rl. Furthermore, on the appearance of a first fault current, the controlled switch Tc of the first capacitor bank is closed in order to discharge the first capacitor bank so as to produce a zero crossing in the current flowing through the branch of the mechanical circuit breaker. On re-engagement of the circuit breaker apparatus, if the fault is still present, the mechanical circuit breaker S1 is reopened and the controlled switch Tc1 connected in series with the second capacitor bank C1 is caused to close so as to discharge the second capacitor bank in order to produce a zero crossing in the current flowing through the branch containing the mechanical circuit breaker.

The circuit breaker apparatus 1 of the disclosure thus enables at least one capacitor bank to be charged simply through at least one resistive voltage divider by means of the high voltage network or the converter. In this respect, it should be observed that in the example shown in FIG. 1, the make switch S2 and the high voltage stage R2s are situated on the network side, whereas in the other embodiment shown, the make switch S2 and the high voltage stage R2s are situated on the converter side. Naturally, the make switch S2 and the high voltage stage R2s may be situated either on the converter side or on the network side.

The circuit breaker apparatus 1 of the disclosure includes a control circuit for the make switch S2 and for the isolating switch S3, which circuit may be made in any suitable way. In general manner, the control circuit serves firstly, after opening of the mechanical circuit breaker S1, to close the make switch S2 quickly in order to produce the oscillating current, and secondly, to open the isolating switch S3 connected in series with the circuit breaker apparatus 1 so as to reinitialize charging of the capacitor bank in order to be ready for a subsequent circuit breaking operation. This control circuit also serves, once the fault current has been eliminated and the capacitor bank discharged, to open the make switch S2 and close the isolating switch S3 connected in series with the circuit breaker apparatus 1.

The disclosure is not limited to the examples described and shown, since various modifications may be made thereto without going beyond its ambit.

What is claimed is:

1-8. (canceled)

9. Circuit breaker apparatus for a high- or medium-voltage direct current network, the circuit breaker apparatus comprising:
a branch with a mechanical circuit breaker inserted in the network line, and, connected in parallel therewith; firstly
a lightning arrestor branch, and secondly a series connection of a first capacitor bank,
a make switch; and
an inductor, the make switch acting on the appearance of a fault current to discharge the capacitor bank through the inductor so as to create an oscillating current and produce a zero crossing in the current flowing in the mechanical circuit breaker branch, wherein the circuit breaker apparatus includes at least one resistive voltage divider connected to the network voltage and presenting a low voltage stage connected in parallel with the capacitor bank in order to charge the capacitor bank.

10. The circuit breaker apparatus according to claim 9, wherein the first resistive voltage divider together with the capacitor bank presents a charging time constant shorter than 100 ms.

11. The circuit breaker apparatus according to claim 9, wherein the first resistive voltage divider presents a ratio between the high voltage stage and the low-voltage stage lying in the range 0.05 to 0.25.

12. The circuit breaker apparatus according to claim 9, including a second resistive voltage divider connected to the network voltage and presenting a low voltage stage connected in parallel with the capacitor bank, the resistance of the low-voltage stage of the first divider being less than the resistance of the low-voltage stage of the second divider, with the division ratio of the first resistive voltage divider being equal to the ratio of the second resistive voltage divider, the stages of the first divider including controlled switches that are caused firstly to close in order to charge the capacitor bank quickly, and secondly to open after charging in order to enable the second divider to maintain the charge of the capacitor bank.

13. The circuit breaker apparatus according to claim 9, including a branch with a second capacitor bank connected in parallel with the low-voltage stage of the first resistive voltage divider and presenting capacitance identical to the capacitance of the first capacitor bank, the first and second capacitor banks each being connected in series with a respective controlled switch, one of which is caused to close on the appearance of a fault current in order to discharge the associated capacitor bank so as to produce a zero crossing in the current flowing through the mechanical circuit breaker branch, and the other of which is caused to close in the event of re-closing on a fault in order to discharge the associated capacitor bank so as to produce a zero crossing in the current flowing in the mechanical circuit breaker branch.

14. The circuit breaker apparatus according to claim 9, characterized in that it includes a system for discharging the capacitor bank, after eliminating the fault current.

15. The circuit breaker apparatus according to claim 14, wherein, as a system for discharging the capacitor bank, it includes the controlled switches of the first resistive divider and the high voltage stage of that first divider, the controlled switches being caused to close in order to discharge the capacitor bank.

16. The circuit breaker apparatus according to claim 9, including a control circuit for the make switch and for the isolating switch serving firstly, after opening of the mechanical circuit breaker, to close the make switch quickly in order to produce the oscillating current, and secondly to open the isolating switch in order to reinitialize charging of the capacitor bank so as to be ready for a subsequent circuit breaking operation.
